(19) United States
(12) Patent Application Publication
(10) Pub. No.: US 2005/0021337 A1
(43) Pub. Date: Jan. 27, 2005

(54) HMM modification method

(76) Inventor: Tae-Hee Kwon, Jeollabuk-Do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/787,017

(22) Filed: Feb. 24, 2004

(30) Foreign Application Priority Data
Jul. 23, 2003 (KR) 2003-50552
Jul. 30, 2003 (KR) 2003-52682

(51) Int. Cl. G10L 15/14

(52) U.S. Cl. 704/256

(57) ABSTRACT

A HMM modification method for preventing an overfitting problem, reducing the number of parameters and avoiding gradient calculation by implementing a weighted loss function for misclassification measure and computing a delta coefficient in order to modify a HMM weight is disclosed. The HMM modification method includes the steps of: a) performing Viterbi decoding for pattern classification; b) calculating misclassification measure using discriminant function; c) obtaining modified misclassification measure for a weighted loss function; d) computing a delta coefficient according to the obtained misclassification measure; e) modifying HMM weight according to the delta coefficient; and f) transforming classifier parameters for satisfying a limitation condition.

### FIELD OF THE INVENTION

The present invention relates to a HMM modification method; and, more particularly, to a HMM modification method for preventing an overfitting problem, reducing the number of parameters and avoiding gradient calculation by implementing a weighted loss function as modified misclassification measure itself and computing a delta coefficient in order to modify a HMM weight.

### DESCRIPTION OF RELATED ARTS

Hidden Markov modeling (HMM) has become prevalent in speech recognition for expressing acoustic characteristics. It is statistically based and links a modeling of acoustic characteristic to a method for estimating distribution of HMM which is distribution estimation method. The most commonly used method out of these distribution estimation methods is the maximum likelihood (ML) estimation method.

However, in the ML estimation method, it is very difficult to find completed knowledge on the form of data distribution and training data. It is always inadequate in dealing with speech recognition. Usually the performance of a recognizer is normally defined by its expected recognition error rate and an optimal recognizer is the one that achieves the least expected recognition error rate. In this perspective, a minimum classification error MCE training method based on generalized probabilistic descent algorithms GPD has been studied.

An object of the MCE training method is not for estimating statistical distribution of data but is for distinguishing object data of HMM for obtaining optimal recognition result. That is, the MCE training method minimizes the recognition error rate.

In a meantime, it has been studied for improving a performance of speech recognition by controlling HMM parameters such as a mixture weight, mean, standard deviation without improved feature extraction, improved acoustic resolution of acoustic model. As an enhanced method of MCE training method, the training of state weights has been studied for optimizing a speech recognizer. The training method using a state weight uses distinct information between speeches in HMM state probability. MCE is usually performed with ML training method and it outperforms estimation of HMM by ML training method.

Hereinafter MCE training method is briefly explained.

In a conventional HMM-based speech recognizer, a discriminant function of class i for pattern classification is defined by the flowing equation as:

$$\begin{matrix}{g}_{i} ( X ; Λ ) = log \{ {g}_{i} ( X , \overline{q} ; Λ ) \} \\ = {\sum }_{t = 1}^{T} [ log {a}_{{\overline{q}}_{t - 1} {\overline{q}}_{t}}^{( i )} + log {b}_{{\overline{q}}_{t}}^{( i )} ( {x}_{t} ) ] + log {π}_{{\overline{q}}_{0}}^{( i )}\end{matrix} \qquad Eq . 1$$

In Eq. 1, Λ is a set of classifier parameters, X is an observation sequence, \overline{q}=(\overline{q}₀,\overline{q}₁, . . . ,\overline{q}_{T}) is the optimal state sequence that maximizes a joint state-observation function for class i, aᵢⱼ denotes the probability of transition from state i to state j.

bⱼ(Xₜ) denotes a probability density function of observing Xₜ at state j. In a continuous multivariate mixture Gaussian HMM, the state output distribution is defined as following equation as:

$${b}_{j} ( {X}_{t} ) = {\sum }_{m = 1}^{M} {c}_{jm} N ( {X}_{t} ; {μ}_{jm} , {\sum }_{jm} ) \qquad Eq . 2$$

In Eq. 2, N( ) denotes a multivariate Gaussian density, μⱼₘ is the mean vector in state j, mixture m and Σⱼₘ is the covariance matrix in stat j, mixture m.

For input utterance, the decision rule is used. For an input utterance X, the class Cᵢ is decided as following rule defined as:

$$C ( X ) = Ci if i = {arg max}_{j} gj ( X ; Λ ) \qquad Eq . 3$$

C(X)=Ci if i=arg max gj(X;Λ) Eq. 3

In Eq. 3, gj(X;Λ) is discriminant function of the input utterance or observation sequence X=(x₁,x₂, . . . ,xₙ) for the jth model.

In first, it is necessary to express the operational decision rule Eq. 3 in a functional form. A class misclassification measure, which is a continuous function of the classifier parameters Λ and attempts to emulate the decision rule, is therefore defined as following equation as:

$${d}_{i} ( X ; Λ ) = - {g}_{i} ( X ; Λ ) + {log [ \frac{1}{N} {\sum }_{j = 1 , j \neq 1}^{N} exp [ {g}_{j} ( X ; Λ ) η ] ]}^{\frac{1}{η}} \qquad Eq . 4$$

In Eq. 4, η is a positive constant and N is the number of N-best competing classes. For an ith class utterance X, dᵢ(X)>0 implies misclassification and dᵢ(X)≦O means correct classification.

The complete loss unction is defined in terms of the misclassification measure using a smooth zero-one function as following:
lᵢ(X;Λ)=l(dᵢ(X;Λ)) Eq. 5

The smooth zero-one function can be any continuous zero-one function, but is typically the following sigmoid function as following:

$$l ( d ) = \frac{1}{1 + exp [ - r d + θ ]} \qquad Eq . 6$$

In Eq. 6, θ is usually set zero or slightly smaller than zero and r is a constant. Finally, for any unknown X the classifier performance is measured by following equation as:

$$l ( X ; Λ ) = {\sum }_{i = 1}^{M} {l}_{i} ( X ; Λ ) 1 ( X ∈ {C}_{i} ) \qquad Eq . 7$$

In Eq. 7, 1(·) is the indicator function.

The optimal classifier parameters are those that minimize the expected loss function. The generalized probabilistic descent GPD algorithm is used to minimize the expected loss function. The GPD algorithm is given by following as:
Λₙ₊₁=Λₙ−εₙUₙ∇l(X;Λ)|_{Λ=Λ}_{ₙ} Eq. 8

In Eq. 8, U is a positive definite matrix, εₙ is the learning rate or step size of adaptation, and Λₙ is the classifier parameter set at time n.

The GPD algorithm is an unconstrained optimization technique. But some constrains must be maintained for HMMs so some modifications are required. Instead of using a complicated constrained GPD algorithm, Chou et al, applied GPD to transform HMM parameters. The parameter transformations ensure that there are no constraints in the transformed space where the updates occur. The following HMM constraints should be maintained in the original space.

The HMM constraints are expressed as:
Σⱼaᵢⱼ=1 and aᵢⱼ≧0, Σₖcⱼₖ=1 and cⱼₖ≧0, σⱼₖₗ≧0 Eq. 9

The following parameter transformations should be used before and after parameter adaptation.
aᵢⱼ→\overline{a}ᵢⱼ where aᵢⱼ=e^{\overline{a}}^{ᵢⱼ}l(Σₖe^{\overline{a}}^{ᵢₖ}) cᵢₖ→\overline{c}ᵢₖ where cᵢₖ=e^{\overline{c}}^{ᵢₖ}l(Σₖe^{\overline{c}}^{ᵢₖ}) μⱼₖₗ→\overline{μ}ⱼₖₗ=μⱼₖₗ/σⱼₖₗ σⱼₖₗ→\overline{σ}ⱼₖₗ=log σⱼₖₗ Eq. 10.

As mentioned above, GPD algorithms based MCE training method requires to calculate of gradient for parameters of HMM and to perform obtainment of optimal state sequence. Such a calculation of gradient and obtainment of the optimal state sequence cause huge amount of calculation. Moreover, the above mentioned HMM state probability modification method produce overfitting problem as the training data is iteratively used for adjusting the misclassification measure.

### SUMMARY OF THE INVENTION

It is, therefore, an object of the present invention to provide a HMM modification method for reducing recognition error rate by eliminating obtainment of optimal state sequence and gradient calculation

It is another object of the present invention to provide a HMM modification method for decreasing amount of calculation by eliminating gradient calculation.

It is still another object of the present invention to provide a HMM modification method for reducing the number of parameters by implementing a weight corresponding to each HMM to thereby improve the performance of speech recognition.

It is further still another object of the present invention to provide a HMM modification method for preventing overfitting problem of the training data by using enhanced loss function.

In accordance with an aspect of the present invention, there is provided a HMM modification method, including the steps of: a) performing Viterbi decoding for pattern classification; b) calculating misclassification measure using discriminant function; c) obtaining modified misclassification measure for a weighted loss function; d) computing a delta coefficient according to the obtained misclassification measure; e) modifying HMM weight according to the delta coefficient; and f) transforming HMM weights for satisfying a limitation condition.

In accordance with another aspect of the present invention there is provided a HMM modification method including a step of obtaining modified misclassification measure by using the weighted loss function \overline{d}ᵢ(X;Λ) which is defined as:

$$\begin{matrix}{\overline{d}}_{i} ( X ; Λ ) = {d}_{i} ( X ; Λ ) - k \cdot {g}_{i} ( X ; Λ ) \\ = - ( 1 + k ) \cdot {g}_{i} ( X ; Λ ) + {log [ \frac{1}{N} {\sum }_{j = 1 , j \neq 1}^{N} exp [ {g}_{j} ( X ; Λ ) η ] ]}^{\frac{1}{η}} ,\end{matrix}$$

wherein i and j is positive integer number and i representing a number of class, gᵢ(X;Λ) is the discriminant function for class I with A being a set of classifier parameters and X is an observation sequence, N is an integer number representing class models and k is positive number representing the number of HMM state.

In accordance with still another aspect of the present invention there is provided a HMM modification method including a step of computing a delta coefficient Δwᵢ, which is obtained based on a discriminant function and the weight loss function defined and is defined as:

$$Δ {w}_{i} = \frac{di ( X ; Λ )}{- gi ( X ; Λ )} ,$$

wherein dᵢ(X;Λ) is the weight loss function for class i and gᵢ(X;Λ) is the discriminant function, Λ is a set of classifier parameters, X is an observation sequence, i is positive integer number representing a number of class.

### BRIEF DESCRIPTION OF THE DRAWING(S)

The above and other objects and features of the present invention will become apparent from the following description of the preferred embodiments given in conjunction with the accompanying drawings, in which:

FIG. 1 is a flowchart of a HMM modification method in accordance with a preferred embodiment of the present invention.

### DETAILED DESCRIPTION OF THE INVENTION

Other objects and aspects of the invention will become apparent from the following description of the embodiments with reference to the accompanying drawings, which is set forth hereinafter.

For helping to understand a HMM modification method in accordance with the present invention, a fundamental concept of the HMM modification method is explained at first.

The HMM modification method adjusts HMM weights according to misclassification measure and iteratively adapts adjusted HMM weights to a pattern classification in order to minimize classification error.

An input utterance is classified by its pattern by using a discriminant function. During classifying pattern, a HMM weight is applied to each HMM. For applying the HMM weight to each HMM, output score of HMM is expressed as multiplication of HMM output probability value and the HMM weight by using viterbi decoding method. For mathematical explanation, it is assumed that M number of HMMs is set up as basic utterance recognition unit and each basic utterance recognition unit is consisted with j number of HMM. A pattern recognition based on HMM is performed by using a class decision rule with the discriminant function of class i. The discriminant function of class i is expressed by Eq. 1. Similarly, the discriminant function of class i in the present invention is expressed by following equation defined as:

$$\begin{matrix}{g}_{i} ( X ; Λ ) = ( {w}_{i} ) [ {\sum }_{t = 1}^{T} \{ log {a}_{{\overline{q}}_{t} - 1 {\overline{q}}_{t}}^{( i )} + log {b}_{{\overline{q}}_{t}}^{( i )} ( {X}_{t} ) \} + log {π}_{{\overline{q}}_{0}}^{( i )} ] \\ = {\sum }_{t = 1}^{T} \{ {w}_{i} \cdot log {a}_{{\overline{q}}_{t} - 1 {\overline{q}}_{t}}^{( i )} + {w}_{i} \cdot log {b}_{{\overline{q}}_{t}}^{( i )} ( {X}_{t} ) \} + \\ {w}_{i} \cdot log {π}_{{\overline{q}}_{0}}^{( i )}\end{matrix} \qquad Eq . 11$$

In Eq. 11, wᵢ is the HMM weight for class i. A summation of HMM weights in a HMM set are limited by total number of HMM as shown in below equation as:

$${\sum }_{i = 1}^{m} {W}_{I} = m , 0 < {w}_{i} < M \qquad Eq . 12$$

By the limitation, a recognition algorithm based on N-best string model obtains identical result when the HMM weight are initially set to 1. It is because smoothly performing recognition process without huge variation of probability value caused by conventional parameter estimation method and viterbi searching algorithm.

After classification pattern of input utterance, a misclassification measure is calculated. In the present invention, weighted loss function is implemented as misclassification measure. That is, the misclassification measure between training class model and N class models is expressed as:

$$\begin{matrix}{\overline{d}}_{i} ( X ; Λ ) = {d}_{i} ( X ; Λ ) - k \cdot {g}_{i} ( X ; Λ ) \\ = - ( 1 + k ) \cdot {g}_{i} ( X ; Λ ) + \\ {log [ \frac{1}{N} {\sum }_{j = 1 , j \neq 1}^{N} exp [ {g}_{j} ( X ; Λ ) η ] ]}^{\frac{1}{η}}\end{matrix} \qquad Eq . 13$$

For the first time, the misclassification measure is modified by adding a weighted likelihood of correct class to the misclassification measure. This modified misclassification measure can be inserted into a sigmoid function to produce the sigmoid zero-one loss function. However, in the present invention, a misclassification measure is considered as a loss function to produce the linear loss function. By using this loss function, gradient associated with a loss function is increased for correct string by a uniform factor k while not affecting the gradient associated with a loss function for incorrect string as shown in Eq. 13.

As a result of modified misclassification measure, another loss functions are sigmoid zero-one loss function where a modified misclassification measure is inserted into a sigmoid function, weighted linear loss function that is exactly the same as a misclassification measure.

After misclassification measure, a delta coefficient is obtained for modified HMM weight.

For controlling the HMM weight for class i, the quantity for adapting HMM weights of class i needs to be set. the quantity for adapting HMM weights of class i is defined as delta coefficient and it is represented by Δwᵢ. By using value of discriminative function di(X;Λ) for class i and misclassification measure gi(X;Λ), the delta coefficient is expressed as below equation as:

$$Δ {w}_{i} = \frac{d i ( X ; Λ )}{- g i ( X ; Λ )} \qquad Eq . 14$$

By using the delta coefficient, a training of HMM weight for class i having 1 as initial value is repeatedly performed according to below equation as:
\overline{w}ᵢ(n+1)=wᵢ(n)−εₙ·wᵢ(n)·Δwᵢ Eq. 15.

Finally, the training of HMM weights is performed by using the Eq. 15 and HMM weights are transformed after HMM weight training. The transformation of parameters is performed by following equation as:
wⱼ→\overline{w}ⱼ where wⱼ=e^{\overline{w}j}|(Σₖe^{\overline{w}}^{ₖ}) Eq. 16

For satisfying the limitation condition that a summation of HMM weights in a HMM set must be equal to total number of HMM in the HMM set, Eq. 16 is applied to HMM weight.

In Eq. 16, \overline{w}ᵢ is a HMM weight of class i of transformed space corresponding to HMM weight wi for class i of original space.

Also, a recognition algorithm for continuous speech recognition performs calculation with considering each HMM weight for viterbi searching step. The recognition algorithm is defined as:
V[0][j]=0, j=π₀V[0][j]=−∞,j≠π₀V[t][j]=max└V[t−1][h]+w(h)·{log aₕⱼ}┘+w(j)·log bⱼ(xₜ) w(j)=wₖ if jεHₖ, k=1,2,Λ,M Eq. 17

In Eq. 17, V[t][j] is an accumulated score at state j in time t. π₀ means initial state and Hₖ means k^{th} HMM. log bⱼ(xₜ) is log probability value when observing an observe vector and wₖ HMM weight of k^{th} HMM.

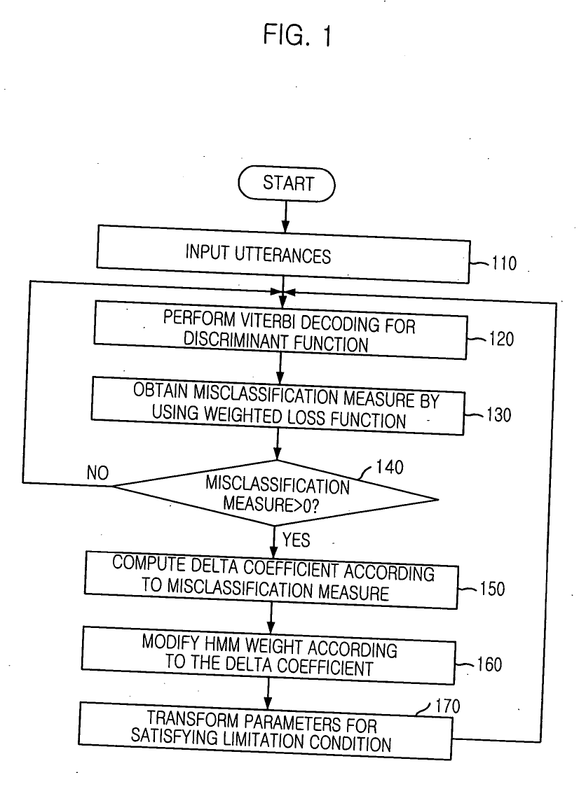

FIG. 1 is a flowchart of a method for modifying HMM weights in accordance with a preferred embodiment of the present invention. There is an assumption that a class i is consisted wit k HMMs for training utterance.

Referring to FIG. 1, at first, utterances are inputted for speech recognition at step S110. For continuous speech recognition, viterbi decoding is performed for computing a discriminant function of each HMM at step S120. After computing the discriminant function, a misclassification measure is obtained according to the discriminant function at step S130. As mentioned above, the modified misclassification measure is used as the weighted loss function or inserted to sigmoid function for signmoid zero-one loss function. By using the misclassification measure Eq. 13 for obtaining the weighted loss function, the overfitting problem of conventional method can be prevented.

If the misclassification measure is a positive number at step S140, a delta coefficient Δwᵢ is computed based on the discriminant function Eq. 11 and the weight loss function Eq. 13. That is, the delta coefficient Δwᵢ is defined by Eq. 14 and is computed for controlling a score for training data in order reduce misclassification measure at step S150.

After computing the delta coefficient, the HMM weight is modified according to the delta coefficient at step S160.

That is, the delta coefficient is reflected to each HMM weight in a training class. The HMM weights in the training class are modified according to below equation as:
\overline{w}k⁽ⁱ⁾(n+1)=wₖ⁽ⁱ⁾(n)−εₙ·wₖ⁽ⁱ⁾(n)·Δwi, k=1,2,Λ,K Eq. 18

In Eq. 18, wₖ⁽ⁱ⁾ is a weight of k^{th} HMM in class I, Δwi is a delta coefficient of class i. Also, εₙ is ration of study in n^{th} training.

After modifying the HMM weight, classifier parameters is transformed for satisfying a limitation condition for HMM weight at step S170 by following equation as:

$$wk -> \overline{w} k where wk = {ⅇ}^{{\overline{w}}_{k}} / ( {\sum }_{x = 1}^{M} {ⅇ}^{{\overline{w}}_{x}} ) \qquad Eq . 19$$

The transformed classifier parameters are implemented to step S120 for better recognition performance.

If the misclassification measure is not positive at step S140 then it is returned to the step S110 for receiving new utterance.

As mentioned above, the present invention can prevent overfitting problem for training data by implementing a weighted loss function for misclassification measure. Furthermore, the present invention can reduce the number of parameters to estimate and avoid gradient calculation by computing a delta coefficient and modifying a HMM weight according to the delta coefficient to thereby reducing computation amount of speech recognition.

While the present invention has been described with respect to certain preferred embodiments, it will be apparent to those skilled in the art that various changes and modifications may be made without departing from the scope of the invention as defined in the following claims.

1. A HMM modifying method, comprising the steps of:
a) performing Viterbi decoding for pattern classification;
b) calculating misclassification measure using discriminant function;
c) obtaining modified misclassification measure for a weighted loss function;
d) computing a delta coefficient according to the obtained misclassification measure;
e) modifying HMM weight according to the delta coefficient; and
f) transforming classifier parameters for satisfying a limitation condition.

2. The method as recited in claim 1, wherein the weighted loss function \overline{d}ᵢ(X;Λ) is defined as:
$$\begin{matrix}{\overline{d}}_{i} ( X ; Λ ) = {d}_{i} ( X ; Λ ) - k \cdot {g}_{i} ( X ; Λ ) \\ = - ( 1 + k ) \cdot {g}_{i} ( X ; Λ ) {log [ \frac{1}{N} {\sum }_{j = 1 , j \neq 1}^{N} exp [ {g}_{j} ( X ; Λ ) η ] ]}^{\frac{1}{η}}\end{matrix}$$
, wherein i and j is positive integer number and i representing a number of class, gᵢ(X;Λ) is the discriminant function for class i with Λ being a set of classifier parameters and X is an observation sequence, N is an integer number representing class models and k is positive number representing the number of HMM state.

3. The method as recited in claim 1, wherein the delta coefficient Δwᵢ is obtained based on the discriminant function and the weighted loss function defined as:
$$Δ {w}_{i} = \frac{d i ( X ; Λ )}{- g i ( X ; Λ )} ,$$
wherein dᵢ(X;Λ) is the weighted loss function and gᵢ(X;Λ) is the discriminant function, Λ is a set of classifier parameters, X is an observation sequence, i is positive integer number representing a number of class.

4. The method as recited in claim 1, wherein in the step f), the classifier parameter is transformed by the limitation condition, which a summation of HMM weights in a HMM set is limited to a total number of HMM in the HMM set, which is defined as:
$${\sum }_{i = 1}^{M} {w}_{i} = M , 0 < {w}_{i} < M ,$$
wherein M is positive integer number representing the number of HMM.

5. The method as recited in claim 1, wherein in the step a), the discriminant function is obtained by a viterbi decoding.
